(19) United States
(12) Patent Application Publication
(10) Pub. No.: US 2007/0208515 A1
(43) Pub. Date: Sep. 6, 2007

(54) Accuracy improvement in strong ion difference for blood gas testing

(76) Inventors: Amar Pal Singh Rana, Sunnyvale, CA (US); Jay Pal Rana, (US); Sam Pal Rana, Sunnyvale, CA (US)

Correspondence Address: Dr. AMAR PAL SINGH RANA, P.O. Box 2279, Sunnyvale, CA, 94087, US

(21) Appl. No.: 11/365,111

(22) Filed: Mar. 2, 2006

(51) Int. Cl. G06F 19/00

(52) U.S. Cl. 702/19

(57) ABSTRACT

An improved bicarbonate determination with variability of apparent dissociation constant in Henderson-Hasselbach equation or Henderson equation with Henry's law is described. The improved bicarbonate is utilized in the determination of improved Strong Ion Difference (SID) and Strong Ion Difference Excess (SIDE) as the change in SID from the reference value at pH=7.4, pCO2=5.33 Kpa (or 40 torr) for blood gas testing.

### BACKGROUND OF THE INVENTION

1. Technical Field

An improved bicarbonate determination with variability of apparent dissociation constant in Henderson-Hasselbach equation or Henderson equation with Henry's law is described. The improved bicarbonate is utilized in the determination of improved Strong Ion Difference (SID), Strong Ion Difference Excess (SIDE) as the change in SID from the reference value at pH=7.4, pCO2=5.33 Kpa (or 40 torr) for blood gas testing.

2. Description of the Related Art

Henderson emphasized the significance of bicarbonate as a reserve of alkali in excess of acids other than carbonic acid. In his now famous monograph, he wrote the law of mass action for carbonate species (the “Henderson equation”) as:
[H⁺]=K₁*[CO₂]/[HCO₃³¹ ] (Eq. 1)
where [CO₂] is the total concentration of dissolved CO₂ gas and aqueous H₂CO₃ in plasma, [H⁺] and [HCO₃⁻] are the concentrations of hydronium and bicarbonate in plasma, and Ki is the equilibrium constant for the association reaction.

Subsequently, Hasselbach and Gammeltoft and Hasselbach adopted the Sorenson convention (where [H⁺] is expressed by pH), and rewrote equation 1 (“the Henderson-Hasselbach equation”) as:
pH=pK′+log [HCO₃⁻]/(Sco₂*Pco₂) (Eq. 2)
where the total CO₂ concentration in expressed as Henry's law, [CO₂]=Sco₂*Pco₂ where Sco₂ (the solubility coefficient of CO₂ in plasma and a constant), Pco₂ (the partial pressure of CO₂ in plasma) and pK′ is a constant. Equation 2 can also be expressed as in equation 2A where K_{1′}=Sco₂*10^{-pK′} and is a conatant:
[HCO3⁻]=K_{1′}*[Pco₂]/[H⁺] (Eq. 2A)

Stewart, a Canadian physiologist put forth a novel approach of acid-base balance with the following features (1) the quantity of H⁺ added or removed from a physiologic system is not relevant to the final pH, since [H⁺] is a “dependent” variable; (2) human plasma consists of fully dissociated ions (“strong ions” such as sodium, potassium, chloride, and lactate), partially dissociated “weak” acids (such as albumin and phosphate), and volatile buffers (carbonate species); (3) an evaluation of nonvolatile buffers equilibrium is important to the description of acid-base balance; (4) the weak acids of plasma can be described as a pseudomonoprotic acid, HA; and (5) plasma membranes may be permeable to strong ions, which constitute the “independent” variable SID, the strong ion difference. Thus transport of strong ions across cell membranes may influence [H⁺].

With these assumptions, Stewart wrote equations based upon the laws of mass action, the conservation of mass, and the conversation of charge.

Water Dissociation Equilibrium
[H⁺]*[OH⁻]=K_{w′} (Eq. 3)
where K_{w′} is the autoionization constant of water
Electrical Neutrality Equation
[SID]+[H⁺]−[HCO₃⁻]−[A⁻]−[CO₃⁻²]−[OH⁻]=0 (Eq. 4)
where SID is the “strong ion difference” ([Na⁺]+[K⁺]−[Cl⁻]−[lactate]) and [A⁻] is the concentration of dissociated weak acids.
Weak Acid Dissociation Equilibrium
[H⁺]*[A⁻]=Kₐ*[HA] (Eq. 5)
where Kₐ is the weak acid dissociation constant of weak acids. Thus, in our case K_{1′} in equation 1 for bicarbonate ion equilibria does not include weak acids contribution as it has been addressed by equations 5 and 6. Further,
[HA]+[A⁻]=[Aₜₒₜ] (Eq. 6)

The three independent variables in Stewart's model are SID, Aₜₒₜ and Pco₂ and determine pH. In addition, one may vary the temperature and any of the rate constants. Physiologiclly, the kidney, intestine and tissue each contribute to SID while lever mainly determines [Aₜₒₜ] and the lungs Pco₂. Acidosis results from an increase in Pco₂, [Aₜₒₜ] or temperature, or a decrease in [SID]. Metabolic acidosis may be due to overproduction of organic acids (e.g. lactic acids, ketoacids, formic acid, salicylate, and sulphate), loss of cations (e.g. diarrhea), mishandling of ions (e.g. RTA) or administration of exogenous anions (e.g. poisoning). These all result in low SID. Alkalosis results from a decrease in Pco₂, [Aₜₒₜ], or temperature, or an increase in [SID]. For example, metabolic alkalosis (e.g. due to vomiting) may be due to chloride loss resulting in high SID. We would like to stress here that it is ultimately, the Electrical Neutrality Equation (equation 4) which provides the balance of all the variables irrespective of whichever variable may emerge to be independent or dependent depending on more accurate future research on mechanisms involved.

U.S. Pat. No. 6,167,412 issued to Simon on Dec. 26, 2000 entitled, “Handheld medical calculator and medical reference device” describes a handheld calculator without any strong ion difference calculations or Henderson-Hasselbach equation solution with variability of pK′ or K₁ or K_{1′}.

U.S. Pat. No. 4,454,229 issued to Zander et. al on Jun. 12, 1984 entitled, “Determination of the acid-base status of blood” describes base excess determination at carbon dioxide partial pressure at 0 torr and photometric determination of pH and no mention of bicarbonate variability due to pK′ or K₁ or K_{1′} or mention of strong ion difference.

U.S. Pat. No. 4,384,586 issued to Christiansen et. al on May 24, 1983 entitled, “Method and apparatus for pH recording” describes continuous or intermittent monitoring of in vivo pH of a patient's blood or plasma without any mention of strong ion difference or bicarbonate or base excess variability due to pK′ or K₁ or K_{1′}.

### SUMMARY OF THE INVENTION

There exists a need for improvement in the accuracy in blood gas testing. It is an object of this invention to improve the accuracy of bicarbonate or HCO3⁻ determination in blood gas testing. It is an object of this invention to improve the accuracy of bicarbonate or HCO3⁻ determination of strong ion difference (SID). It is also an object of this invention to improve the accuracy of blood gas testing without increasing health care costs.

### DETAILED DESCRIPTION OF THE INVENTION

In one aspect of our invention, we directly measure [HCO₃⁻] for fast and high volume blood testing typicaily utilizing ion sensing electrodes (ISE) in electro-chemical sensor based analytical measurements and include the directly measured [HCO₃⁻] into the calculation for strong ion difference utilizing equation 4, 9 or 10 or SIDE calculation utilizing equation 11.

In another aspect of our invention, we utilize S_{CO2} and pK′ values for bodily fluids which are dependent on ionic strength, protein concentration, etc. in computing strong ion difference by substituting for [HCO₃⁻] from equation 2 into equations 4 and utilizing pK′ values from equation 6B at 37° C. or by interpolation or extrapolation from equation 6B. Similarly Sco2 from equation 6A may also be utilized. Heisler developed complex equations for S_{CO2} (mmol 1-1 mmHg−1) (1 mmHg=133.22 Pa) and pK′ that are purported to be generally applicable to aqueous solutions including body fluids between 0° and 40° C. and incorporate the molarity of dissolved species (Md), solution pH, temperature (T, ° C.), sodium concentration ([Na⁺], mol 1-1), ionic strength of non-protein ions (I, mol 1-1) and protein concentration ([Pr], g 1-1) and are also referenced by Stabenau and Heming but not utilized for SID calculation:
S_{CO2}=0.1008−2.980×10−2Md+(1.218×10−3Md−3.639×10−3)T−(1.957×10−5Md−6.959×10−5)T2+(7.171×10−8Md−5.596×10−7)T3. (Eq. 6A)
pK′=6.583−1.341×10−2T+2.282×10−4T2−1.516×10−6T3−0.341I0.323−log {1+3.9×10−4[Pr]+10A(1+10B)}, (4) where A=pH−10.64+0.011T+0.737I0.323 and B=1.92−0.01T−0.737I0.323+log [Na⁺]+(0.651−0.4941)(1+0.0065[Pr]) (Eq. 6B)
Equation 6A or 6B may also be expressed in the form of table, graph, curve, algorithm, nomogram or curve nomogram and may also be programmed into a computer or microprocessor.

In yet another aspect of our invention we utilize the variation of K_{1′} as K_{1′} versus SID (equation 7), corrected for Na⁺, ionic strength, etc. to obtain corrected SID via equation 9 or 10. While both Sco₂ and pK′ in equation 2 are not constants and vary with ionic strength, temperature, pH and protein concentration, the variation of pK′ is much more significant in non-logarithmic form of equation 1 when temperature is fixed at 37° C. We find that K_{1′}=0.03*10^{-pK′} where Sco2 is taken to be reasonably constant 0.03 mmol/L*Hg at 37° C. Once the temperature is fixed, at 37° C., pK′ varies strongly with ionic strength. Abnormal plasma Na-levels fluctuations over hours and days in a given patient are not uncommon. The variation in pK′ with ionic strength is particularly evident if logarithmic scale is not used. Hyponatraemia or hypematraemia i.e. variation in Plasma Na levels (and thus Strong Ion Difference in general) contributes significantly to variations in K_{1′}. Such large corrections are very obvious when applied to Strong Ion Difference model which does not utilize logarithmic scale. We converted the data in the literature from pK′ versus ionic strength to K_{1′} Versus SID when only bicarbonate and strong ions are present (as contributions to SID by weak acids are accounted for separately by utilizing equations 5 and 6) utilizing equations 1 and 4 and find it to be:
K_{1′}=2.3*10⁻¹¹+0.0355778*10⁻¹¹*SID (Eq. 7)
Carbonate Ion Formation Equilibrium
[H⁺]*[CO₃⁻²]=K₃*[HCO₃−] (Eq. 8)
where K₃ is the apparent equilibrium dissociation constant for bicarbonate.

Combining the above equations and K₃=6*10⁻¹¹ equiv/L, Kw′=4.4*10⁻¹⁴ (equiv/L)², we obtain the “Corrected Stewart Equation”:
[SID]+[H⁺]−[2.3*10⁻¹¹+0.0355778*10⁻¹¹*SID]*Pco₂/[H⁺]−Kₐ*[Aₜₒₜ]/(Kₐ+[H⁺])−K₃*(2.3*10⁻¹¹+0.0355778*10⁻¹¹*SID)Pco₂/[H⁺]²−K_{w′}/[H⁺]=0 (Eq. 9)
Figge et. al further refined Aₜₒₜ to Albumin, [Alb] in g/dL and Phosphates, [Phos] in nmol/L and with equation 9 results in corrected SID:
SID=(2.3*10⁻¹¹*Pco₂/[H⁺]10[Alb](0.12*pH−0.631)+[Phos](0;309* pH−0.469)+2.3*10⁻²²*6*Pco₂/[H⁺]²+K_{w′}/[H⁺]−[H⁺])/(1−0.0355778*10⁻¹¹* Pco₂/[H⁺]−0.0355778*6*10⁻²²*Pco₂/[H⁺]²) (Eq. 10)
It may be also be noted that Aₜₒₜ/Albumin do provide a fair share to the value of corrected SID and there is no doubt about the contributions due to variations in Pco₂.

In yet another aspect of our present invention, we further introduce “Strong Ion Difference Excess” (SIDE) as the change in corrected SID from the reference value of 23.2 milli-equiv/L at pH=7.4, pCO₂=5.33 Kpa (or 40 torr or 40 mm Hg) and independent of hemoglobin and weak proteins and unidentified components. The SIDE is particularly a quick useful measure when one can rule out the effects of hemoglobin and weak proteins and unidentified components. Thus, ignoring weak proteins, albumin and smaller terms from equation 10, we obtain:
SIDE=(((2.3*10⁻¹¹*Pco₂/[H⁺])/(1−(0.0355778*10⁻¹¹*Pco₂/[H⁺]−0.0355778*6*10⁻²²*Pco₂/[H⁺]²))−0.0232) (Eq. 11)
According to our definition SIDE is zero for values of Pco₂=40 Torr and for pH=7.4.

### BRIEF DESCRIPTION OF THE DRAWINGS

FIG. 1 shows the result of our improvements for SID for fixed pK′=6.1, SID for exact measured pk′ values and improved SID for the data points of Hastings and Sendroy data.

### DETAILED DESCRIPTION OF THE DRAWINGS

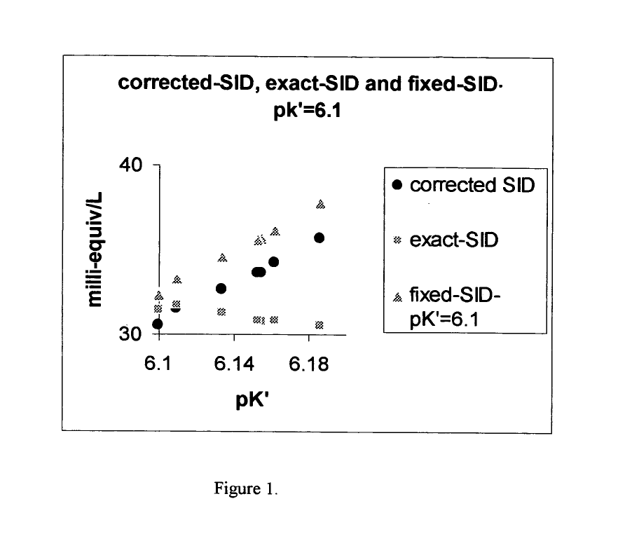

FIG. 1 shows the fixed-SID for pK′=6.1 (or K_{1′}=2.46*10⁻¹¹ (equiv/L)²/mmHg, assumed constant), exact-SID for the measured data points by utilizing the exact pK′ values Hastings and Sendroy data and corrected-SID, corrected for pK′ variability by absorbing pK′ (or K_{1′}) versus exact-SID (equation 7) into the corrected-SID calculations (equation 10). Note the improvement in the corrected-SID being closer to exact-SID values than the fixed-SID values without having resort to costly and error prone measurements of the ionic strength, etc. there by reducing health care costs. The x-axis reflects various data points shown as pK′ values of Hastings and Sendroy data.

In another aspect of our invention directly measured values of SID may be utilized by an array of ion sensing electrodes for strong ions. To measure SID requires, depending upon the precision to which one aspires, the measurement of strong ion concentrations including Na⁺, K⁺, Cl⁻, Ca⁺⁺, Mg⁺⁺, sulfate, urate, keto metbolites and lactate with their attendant costs.

The measurement of [Na⁺] or total ionic strength would also be susceptible to inaccuracies and added cost. In yet another aspect of our invention, the computation of corrected SID as in equation 10 incorporating the variability of K_{1′}(along with [H⁺]/pH, Pco₂) and Aₜₒₜ/Albumin contribution and additional testing of keto acids in diabetics and other species where warranted is an integrated and a more accurate and complete measure of respiratory/non-respiratory equilibria of blood plasma. Thus computation of corrected SID, rather than its experimental measurement is also a pragmatic approach with a sound biological, chemical and mathematical basis.

It should be understood that the foregoing description is only illustrative of the invention. Various alternatives and modifications can be devised, without departing from the spirit and scope of the invention.

What is claimed is:

1. A method of improved strong ion difference determination of a fluid comprising
electro-neutrality equation expressed as sum of positive ions charges equal to sum of negative ion charges and
laws of mass action for bicarbonate or HCO₃⁻, H⁺, albumin, weak proteins, organic and inorganic phosphates, sulphate, carbonate, keto and lactate ions or metabolites and
Henderson-Hasselbach equation or
Henderson equation and Henry's law
at a fixed temperature.

2. A method of improved strong ion difference determination of a fluid as in claim 1 wherein said bicarbonate or HCO₃⁻ is determined by
said Henderson-Hasselbach equation: pH=pK′+log [HCO₃⁻]/(Sco₂.Pco₂)
wherein Sco₂ is the solubility coefficient, Pco₂ is the partial pressure of carbon dioxide, pH is −log [H⁺], [H⁺] is the H⁺ ion concentration, [HCO₃⁻] is bicarbonate ion concentration and pK′ is a variable or
or said Henderson equation: [H⁺]=K₁*[CO₂]/[HCO₃⁻], with said Henry law: [CO₂]=Sco₂*PCO₂, becomes [HCO3⁻]=K_{1′}*[Pco₂]/[H⁺]
wherein [CO2] is the carbon dioxide concentration, [H⁺] is the H⁺ ion concentration, [HCO₃⁻] is bicarbonate ion concentration, K₁ is a variable, Sco₂ is the solubility coefficient, Pco₂ is the partial pressure of carbon dioxide and K_{1′} is a variable.
at a said fixed temperature

3. A method of improved strong ion difference determination as in claim 1 wherein measured value of said bicarbonate or said HCO₃⁻ is utilized.

4. A method of improved strong ion difference determination as in claim 1 wherein measured value of said bicarbonate or said HCO₃⁻ utilizing ion sensing electrode responsive only to said bicarbonate or said HCO₃⁻.

5. A method of improved strong ion difference determination as in claim 1 wherein measured value of said strong ion difference is utilized.

6. A method of improved strong ion difference determination as in claim 1 wherein said strong ion difference is calculated by subtracting sum of negatively charged strong ions from the sum of positively strong charged ions and wherein the concentration or activity is measured by calibrated voltage or current through an array of ion sensing electrodes responsive to positively and negatively charged strongly dissociated ions except said carbonate, bicarbonate or HCO₃⁻, H⁺, albumin, weak proteins, organic and inorganic phosphates.

7. A method of improved strong ion difference determination as in claim 1 wherein said strong ion difference is calculated by subtracting sum of negatively charged strong ions from the sum of positively strong charged ions and wherein the concentration or activity is measured by calibrated voltage or current through an array of ion sensing electrodes responsive to positively and negatively charged strongly dissociated ions except said carbonate, bicarbonate or HCO₃⁻, H⁺, albumin, weak proteins, organic and inorganic phosphates are bound.

8. A method of improved strong ion difference determination as in claim 1 wherein strong ion difference is calculated from concentration or activity measurement by calibrated voltage or current through an array of ion sensors electrodes responsive to said carbonate, bicarbonate or HCO₃⁻, albumin and phosphates ions or metabolites and utilizing equation:
Strong ion difference (milli-equivalent/liter)=[HCO₃⁻](milli Equivalent/Liter)+[carbonate](milli Equivalent/Liter)+[albumin](milli Equivalent/Liter)+[phosphates](milli Equivalent/Liter).

9. A method of improved strong ion difference determination as in claim 1 wherein calculated value said bicarbonate is obtained from said Henderson equation with said variable K₁.

10. A method of improved strong ion difference determination as in claim 1 wherein calculated value said bicarbonate is obtained from said Henderson equation and said Henry's law with said variable K_{1′}.

11. A method of improved strong ion difference determination as in claim 1 wherein said variable K_{1′} or K₁ value is obtained from a table, equation, graph or curve of said K_{1′} or said K₁ respectively as function of at least one of a plurality of ionic strength, sodium, protein, pH, albumin, globulin, hemoglobin, inorganic and organic phosphate, keto metabolites, lactic metabolites, weak protein concentrations and said temperature.

12. A method of improved strong ion difference determination as in claim 1 wherein calculated value said bicarbonate is obtained from said Henderson-Hasselbach equation with said variable pK′.

13. A method of improved strong ion difference determination as in claim 1 wherein said variable pK′ value is obtained from a table, equation or curve or graph of said pK′ as function of at least one of a plurality of ionic strength, sodium, protein, pH, albumin, globulin, hemoglobin, inorganic and organic phosphate, keto, lactic metabolites, weak proteins concentrations and said temperature.

14. A method of improved strong ion difference determination as in claim 1 wherein said calculation is performed at or interpolated or extrapolated to said fixed temperature in the range of 30 to 45 degrees Celsius.

15. A method of improved strong ion difference determination as in claim 1 wherein said fluid is human blood, urine, plasma, saliva, spinal fluid, serum or blood diluted by one to five times the volume of the said same blood plasma.

16. A method of improved strong ion difference determination as in claim 1 wherein said variable pK′ or said K_{1′} or said K₁ is a function of strong ion difference.

17. A method of calculating corrected strong ion difference as in claim 1 wherein the said strong ion difference is calculated as the difference between said strong ion difference value and the reference value of said strong ion difference at 40 mm Hg carbon dioxide pressure, 37 degrees Celsius and 7.4 pH.

18. A method of calculating corrected strong ion difference as in claim 1 wherein the said strong ion difference is calculated as the difference between said strong ion difference value and the reference value of said strong ion difference at 40 mm Hg carbon dioxide pressure, 37 degrees Celsius and 7.4 pH at zero value of said albumin, weak proteins, carbonate, phosphate ions or metabolites.

19. A computer implemented system for performing strong ion difference calculation for a fluid, the system having a processor and a memory coupled via a bus, the memory containing computer readable instructions which when executed by the processor cause the system to implement a method comprising:
electro-neutrality equation expressed as sum of positive ions charges equal to sum of negative ion charges and
laws of mass action for bicarbonate or HCO₃⁻, H⁺, albumin, weak proteins, organic and inorganic phosphates, sulphate, keto and lactate ions or metabolites and
Henderson-Hasselbach equation: pH=pK′+log [HCO₃⁻]/(Sco₂.Pco₂) wherein Sco₂ is the solubility coefficient, Pco₂ is the partial pressure of carbon dioxide, pH is −log [H⁺], [H⁺] is the H⁺ ion concentration, [HCO₃⁻] is bicarbonate ion concentration and pK′ is a variable or
Henderson equation: [H⁺]=K₁*[CO₂]/[HCO₃⁻], with said Henry law: [CO₂]=Sco₂*Pco₂, becomes [HCO₃⁻]=K_{1′}*[Pco₂]/[H⁺]
wherein [CO2] is the carbon dioxide concentration, [H⁺] is the H⁺ ion concentration, [HCO₃⁻] is bicarbonate ion concentration, K₁ is a variable, Sco₂ is the solubility coefficient, Pco₂ is the partial pressure of carbon dioxide and K_{1′} is a variable or
measured value of said bicarbonate or said HCO₃⁻ is utilized or
by subtracting sum of negatively charged strong ions from the sum of positively strong charged ions and wherein the concentration or activity is measured by calibrated voltage or current through an array of ion sensing electrodes responsive to positively and negatively charged strongly dissociated ions except said carbonate, bicarbonate or HCO₃⁻, H⁺, albumin, weak proteins, organic and inorganic phosphates or
by subtracting sum of negatively charged strong ions from the sum of positively strong charged ions and wherein the concentration or activity is measured by calibrated voltage or current through an array of ion sensing electrodes responsive to positively and negatively charged strongly dissociated ions except said carbonate, bicarbonate or HCO₃⁻, H⁺, albumin, weak proteins, organic and inorganic phosphates are bound or
calculated from concentration or activity measurement by calibrated voltage or current through an array of ion sensors electrodes responsive to said carbonate, bicarbonate or HCO₃⁻, albumin and phosphates ions or metabolites and utilizing equation:
Strong ion difference (milli-equivalent/liter)=[HCO₃⁻](milli Equivalent/Liter)+[carbonate](milli Equivalent/Liter)+[albumin](milli Equivalent/Liter)+[phosphates](milli Equivalent/Liter) or
wherein variable K₁, K_{1′} or pK′ value is obtained from a table, equation, graph or curve of said K_{1′} as function of at least one of a plurality of ionic strength, sodium, protein, pH, albumin, globulin, hemoglobin, inorganic and organic phosphate, keto metabolites, lactic metabolites, weak protein concentrations and temperature and
said fluid is human blood, urine, plasma, saliva, spinal fluid, serum or blood diluted by one to five times the volume of the said same blood plasma or
said variable pK′ or said K_{1′} is a function of strong ion difference or
said strong ion difference is calculated as the difference between said strong ion difference value and the reference value of said strong ion difference at 40 mm Hg carbon dioxide pressure, 37 degrees Celsius and 7.4 pH at zero or non-zero values of said albumin, weak proteins, carbonate, phosphate ions or metabolites and
at a fixed temperature in the range of 30 to 45 degrees Celsius.

20. A computer implemented system for performing bicarbonate or HCO₃⁻ calculation for a fluid, the system having a processor and a memory coupled via a bus, the memory containing computer readable instructions which when executed by the processor cause the system to implement a method comprising:
Henderson-Hasselbach equation: pH=pK′+log [HCO₃⁻]/(Sco₂.Pco₂) wherein Sco₂ is the solubility coefficient, Pco₂ is the partial pressure of carbon dioxide, pH is −log [H⁺], [H⁺] is the H⁺ ion concentration, [HCO₃⁻] is bicarbonate ion concentration and pK′ is a variable or
Henderson equation: [H⁺]=K₁*[CO₂]/[HCO₃⁻], with said Henry law: [CO₂]=Sco₂*Pco₂, becomes [HCO3⁻]=K_{1′}*[Pco₂]/[H⁺]
wherein [CO2] is the carbon dioxide concentration, [H⁺] is the H⁺ ion concentration, [HCO₃⁻] is bicarbonate ion concentration, K₁ is a variable, Sco₂ is the solubility coefficient, Pco₂ is the partial pressure of carbon dioxide and K_{1′} is a variable and
pK, K₁ or K_{1′} value is obtained respectively from a table, equation, graph or curve of said pK′, K₁ or K_{1′} as function of at least one of a plurality of ionic strength, sodium, protein, pH, albumin, globulin, hemoglobin, inorganic and organic phosphate, keto metabolites, lactic metabolites, weak protein concentrations and temperature and
said fluid is human blood, urine, plasma, saliva, spinal fluid, serum or blood diluted by one to five times the volume of the said same blood plasma.
at a fixed temperature in the range of 30 to 45 degrees Celsius.
